(19) United States
(12) Patent Application Publication
(10) Pub. No.: US 2016/0231938 A1
(43) Pub. Date: Aug. 11, 2016

(54) STORAGE CONTROL DEVICE AND CONTROL METHOD IN STORAGE CONTROL DEVICE

(71) Applicant: CANON KABUSHIKI KAISHA, Tokyo (JP)

(72) Inventor: KOJI NIWA, Kawasaki-shi (JP)

(21) Appl. No.: 15/010,065

(22) Filed: Jan. 29, 2016

(30) Foreign Application Priority Data
Feb. 9, 2015 (JP) 2015-023118

(51) Int. Cl. G06F 3/06

(52) U.S. Cl. CPC G06F 3/0604; G06F 3/0629; G06F 3/0689

(57) ABSTRACT

There is provided a storage control device which performs mirroring by using a plurality of storage devices detects an activation state of each of the plurality of storage devices; and permits a Read request in a first state in which it is determined that one storage device is activated, and a Write request in a second state in which it is determined that the plurality of storage devices are activated.

### BACKGROUND OF THE INVENTION

1. Field of the Invention

The present invention is a technique relating to control at power-on by a storage control device on which a plurality of HDDs (Hard Disk Drives) are mounted.

2. Description of the Related Art

Disk array devices employing a plurality of storage devices (for example, an HDD) have been known. A disk array device is connected to a host, which is an upper device, and acts like a single storage device as viewed from the host. The disk array device is also connected to a lower device, for example, two storage devices, and performs mirroring (RAID 1) of the storage devices without being noticed by the host.

In an image processing apparatus including such a disk array device, at power-on of the apparatus, power is supplied to devices in the image processing apparatus. Once the power is supplied, two storage devices connected to the disk array device each perform initial operation such as spin-up and once the two storage devices become available for use, the two storage devices notify the disk array device, which is an upper device, of completion of the initial operation. Upon receipt of notification of completion of the initial operation from all the storage devices, the disk array device notifies the host of the completion of the initial operation. After the notification is completed, the disk array device controls the two storage devices to become available for responding to requests from the host (for example, Read request and Write request).

Here, for example, in a case where the disk array device is used in the image processing apparatus, at power-on of the apparatus, power needs to be supplied to devices performing various functions, such as a printing device and a scanner device, as well as the above-described disk array device and storage device. Meanwhile, the maximum power amount to be supplied to the image processing apparatus is limited according to the capacity of a power control unit mounted thereon. Even in case of power-on at which the power consumption is large, naturally, the power needs to be controlled so as not to exceed the maximum power amount.

Japanese Patent Laid-Open No. 2009-271637 discloses a technique of performing control so as to reduce peak power at power-on by delaying power supply to part of devices. Particularly, in a case where HDDs are used, the power consumption tends to become large upon performing of spin-up which is included in the initial operation. Therefore, power is supplied first to one of the two HDDs to allow the one HDD to perform the initial operation and then to the other HDD, thereby enabling the peak power to be reduced.

As described above, once the notification of the completion of the initial operation of all the plurality of HDDs is received, the disk array device can respond to a request from the host. Therefore, if timing of power supplied to each of the HDDs is shifted, the time at which the disk array device can respond to the request from the host is delayed by the amount of the time shifted. For example, in a case of the image processing device, a CPU which is a host reads out firmware for control and set values or the like on each of the devices from the storage device, develops the read data to a RAM or the like, and read out the stored data to controls each of the devices. Therefore, shifting the timing of power supplied to each of the HDDs consequently causes a delay in the time at which the image processing apparatus becomes available for use after the image processing apparatus is powered on.

### SUMMARY OF THE INVENTION

A storage control device according to the present invention is a storage control device for controlling data stored in a first storage device and a second storage device, the storage control device comprising: a detection unit configured to detect activation states of the first storage device and the second storage device; and a control unit configured to permit a first processing request, with respect to the storage devices, the first processing request capable of being processed with only activation of the first storage device, in a case where the detection unit detects that only the first storage device is activated, and to permit processing requests, including the first processing request, with respect to the storage devices, in a case where the detection unit detects that the first storage device and the second storage device are activated.

Further features of the present invention will become apparent from the following description of exemplary embodiments (with reference to the attached drawings).

### BRIEF DESCRIPTION OF THE DRAWINGS

FIG. 1 is a block diagram showing a configuration of an image processing apparatus according to an embodiment;

FIG. 2 is a flowchart showing control of power to HDDs performed by a power control unit at power-on of the image processing apparatus according to the embodiment;

FIG. 3 is a flowchart showing control performed by a mirroring control unit at power-on of the image processing apparatus according to the embodiment;

FIG. 4 is a flowchart showing control in a case where the mirroring control unit receives a request from an upper device according to the embodiment; and

FIG. 5 is a chart showing an example of effects according to the embodiment.

### DESCRIPTION OF THE EMBODIMENTS

Embodiments of the present invention will be described below with reference to the attached drawings. It should be noted that a configuration shown in the following embodiment is a mere example, and the present invention is not limited to the configuration shown in the drawings.

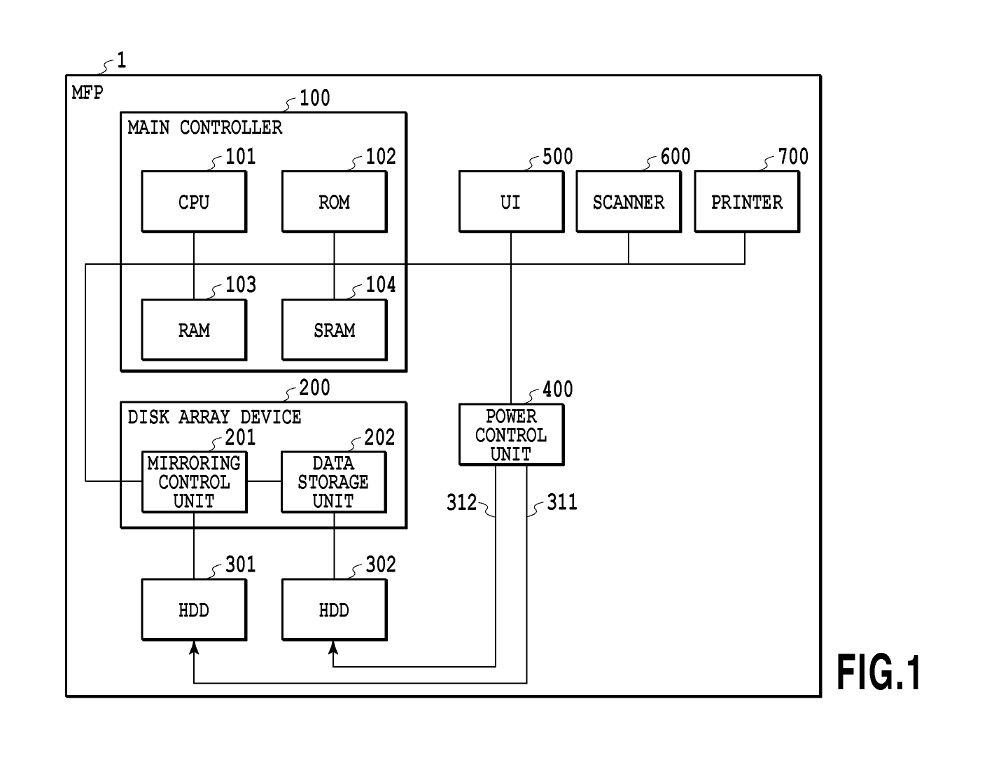

FIG. 1 is a block diagram showing a configuration of an MFP (Multifunction Peripheral) 1. The MFP 1, which is an exemplary image processing apparatus, comprises a main controller 100, a disk array device 200, an HDD 301, an HDD 302, a power control unit 400, a UI 500, a scanner 600, and a printer 700. It should be noted that in the present embodiment, the image processing apparatus is described as an example, but the apparatus is not limited to the image processing apparatus. Specifically, the apparatus may be any apparatus using the disk array device 200 and may be an information processing apparatus (such as a PC). Further, the disk array device 200, the HDD 301, and the HDD 302 may be devices external to the MFP 1. For example, the disk array device 200 and the HDD 302 may be removable, as an option, from the MFP 1. In a case where the disk array device 200 and the HDD 302 are not mounted, the HDD 301 is directly connected to the main controller 100.

The main controller 100 generally controls the MFP 1. The main controller 100 comprises a CPU 101, a ROM 102, a RAM 103, and an SRAM 104. The CPU 101 controls each of components in the main controller 100, the disk array device 200, the UI 500, the scanner 600, the printer 700, and the like. The ROM 102 stores programs and the like used by the CPU 101 and the RAM 103 functions as a work area or the like where the CPU 101 performs operations. The SRAM 104 stores each piece of data used by the CPU 101 in performing operations. The main controller 100 functions as an upper device (host) of the disk array device 200.

According to an instruction from the main controller 100, the disk array device 200 (storage control device) writes data to the HDD 301 and HDD 302 or reads data from the HDD301 and HDD302. The disk array device 200 has a mirroring control unit 201 and a data storage unit 202. The mirroring control unit 201 performs mirroring of the HDD 301 and HDD 302. Mirroring is a technique in which the same data is written to a plurality of HDDs (in the present embodiment, two HDDs), and upon the occurrence of failure in one of the HDDs, the data written to the other HDD is used to enable restoration of the data. The data storage unit 202 stores each piece of data for use in mirroring and employs, for example, a flush ROM, an SRAM which retains data with a button type battery, or the like. Data stored in the data storage unit 202 includes the types and the number of HDDs. According to the present embodiment, the data storage unit 202 stores permission state information indicating permission state with respect to a request from the upper device (the main controller 100 in FIG. 1). The permission state information includes information indicating that, for example, out of the requests from the upper device, only a Read request is permitted, all the requests including Read and Write are permitted, or none is permitted. The permission state information can be implemented, for example, by using a flag indicating each of the above states with predetermined values. The mirroring control unit 201 switches processing by referring to the permission state information if the mirroring control unit 201 receives a request from the upper device. The details will be described later. It should be noted that with respect to the permission state information, the flag is set in such a manner that none of the requests is permitted at power-on. The HDD 301 and HDD 302 are non-volatile storage devices for storing data. Power is controlled by the power control unit 400, which will be described later, to be supplied to the HDD 301 and HDD 302 via a power line 311 and a power line 312, respectively. It should be noted that the storage device may be a storage device (such as an SSD (Solid State Drive)) other than an HDD.

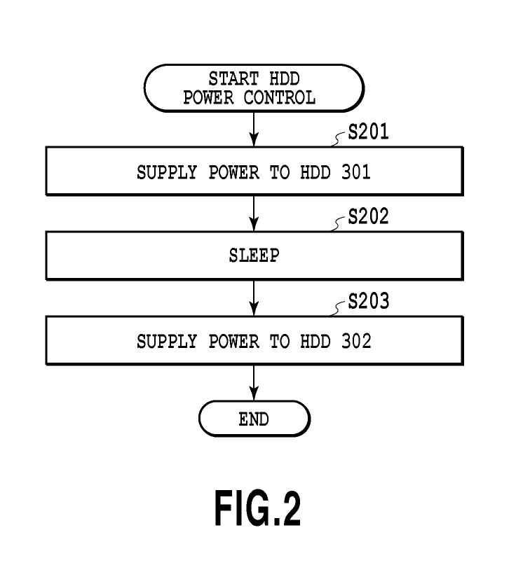

The power control unit 400 controls power to each of blocks of the MFP 1 shown in FIG. 1. At power-on of the MFP 1, for example, upon receipt of power from an external power source (not shown), the power control unit 400 starts control of power supply to each of the blocks. Upon receipt of the power, each of the blocks performs predetermined initialization or the like. Once the initialization of each of the blocks is completed, the MFP 1 becomes available for use. In this view, all the blocks are preferably supplied with power at the start of the power supply if the power consumption for all the blocks is within an allowable range of the power control unit. However, in a case where the power control unit is configured to increase the capacity of the power consumption so as to match the highest power consumption which is reached at power-on or the like, the cost will also increase accordingly. To avoid this, power is controlled to reduce peak power in such a manner as follows: power is supplied first to the main controller 100 and the printer 700 which consume time for the initialization; during the initialization of the main controller 100, power is supplied to the disk array device 200, HDD 301, and HDD 302 which are necessary for reading data on firmware or the like; and power is then supplied to the UI 500 and scanner 600. The control of power supply to the HDDs will be described later with reference to FIG. 2, and the details of control of power to blocks other than the HDDs will be omitted because the control is not related to the characteristic processing according to the present embodiment.

The UI 500 provides a user, via a display, with various types of information and transmits input from the user via a button or the like to the main controller 100. The scanner 600 input an image of document obtained by reading the document and the printer 700 performs printing based on the image data input by the scanner 600 or the like.

FIG. 2 is a flowchart showing control of power to the HDDs performed by the power control unit 400 at power-on of the MFP 1. As described above, the power control unit 400 supplies power to each of the blocks at power-on. FIG. 2 shows a process of power supply to the HDDs out of the processes of power supply to each of the blocks at power-on.

In step S201, at power-on, the power control unit 400 supplies power first to the HDD 301, one of the storage devices, and then, in step S202, waits until the power consumption of the HDD 301 is reduced. The waiting time is set in designing of the image processing apparatus such that the peak power does not exceed the capacity of the power control unit. For example, in a case where the power does not exceeded the capacity of the power control unit 400 even after the power supply to the HDD 302 is started just one second from the start of power supply to the HDD 301, the power control unit 400 waits for one second, and subsequently, in step S203, the power control unit 400 supplies power to the HDD 302, the other storage device. In this manner, the power control unit 400 performs control by sliding the start-up timing of the HDDs such that the peak power does not exceed the capacity of the power control unit.

It should be noted that explanation has been given here of an example in which the power control unit 400 supplies power to the HDD 301 and HDD 302 in this order, but power may be supplied in the reverse order. The present embodiment is not limited to the case where power is supplied to the HDD 301 and HDD 302 in this specific order, but for example, the power may be supplied to the HDD 302, followed by a waiting time, and then to the HDD 301.

Further, explanation has been given here of the case where the power control unit 400 supplies power to the HDD 301, then waits for a predetermined period of time, and thereafter supplies power to the HDD 302. However, the power control unit 400 may be configured so as to monitor the power in use at start-up of the HDD 301 and after detection of the power consumption monitored being reduced to a predetermined value, supply power to the HDD 302.

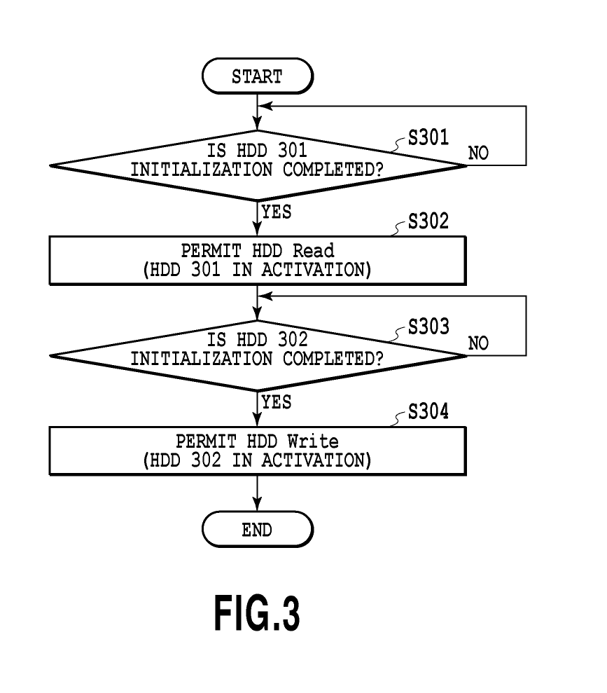

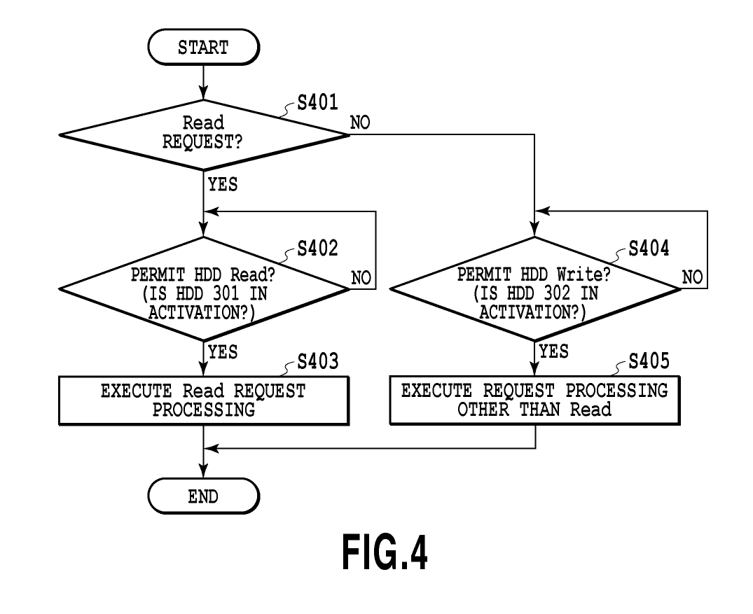

FIG. 3 and FIG. 4 are flowcharts showing control performed by the mirroring control unit 201 at power-on of the MFP 1. At power-on of the MFP 1, the mirroring control unit 201 is supplied with power from the power control unit 400 and starts control of lower devices and control of waiting for a request from the upper device. First, with reference to FIG. 3, control of waiting for a response from the storage devices (HDD 301 and HDD 302) which are the lower devices will be described, followed by explanation of the control of waiting for a request from the main controller 100 which is the upper device, with reference to FIG. 4.

First, with reference to FIG. 3, explanation will be given of the control by the mirroring control unit 201 of waiting for a response from the storage devices (HDD 301 and HDD 302). By receiving predetermined notification from the storage devices (HDD 301 and HDD 302), the mirroring control unit 201 can detect activation states of the storage devices (HDD 301 and HDD 302). In step S301, the mirroring control unit 201 confirms whether notification of completion of the initialization is received from the storage device to which the power is supplied first, namely, the HDD 301, stated above with reference to FIG. 2. More specifically, the mirroring control unit 201 detects whether the initialization of the HDD 301 at power-on is completed. It should be noted that the mirroring control unit 201 does not necessarily need to know which of the HDD 301 and HDD 302 is first supplied with power. In other words, the mirroring control unit 201 only needs to confirm whether the notification of the completion of the initialization is received from any of the storage devices.

Once the notification of the completion of the initialization is received from the HDD 301, in step S302, the mirroring control unit 201 moves to a state in which among processing requests from the upper device, Read of data is only permitted. For example, the mirroring control unit 201 stores, in the data storage unit 202, permission state information indicating that Read of data is only permitted.

Next, in step S303, the mirroring control unit 201 confirms whether notification of completion of the initialization of the storage device whose completion of initialization is not yet confirmed. Namely, the mirroring control unit 201 confirms whether notification of completion of the initialization of the HDD 302 is received. Since according to the present embodiment, two HDDs are connected, once the notification of the completion of the initialization of the HDD 302 is received, the process proceeds to the next step S304. It should be noted that if a plurality of storage devices are further connected and mirroring is performed, the process may proceed to the next step S304 at the completion of the initialization of all the storage devices.

Once the notification of the completion of the initialization is received from the HDD 302, in step S304, the mirroring control unit 201 moves to a state in which among processing requests from the upper device, all the requests including Write of data are permitted. For example, the mirroring control unit 201 stores, in the data storage unit 202, permission state information indicating that all the requests including Read and Write are permitted.

Next, with reference to FIG. 4, explanation will be given of control performed by the mirroring control unit 201 each time of receiving requests from the main controller 100.

In step S401, upon receiving a request from the main controller 100, the mirroring control unit 201 confirms whether the request is a Read request. If the request is the Read request, the mirroring control unit 201 moves to step S402. It should be noted that if the request from the main controller 100 is a request which can be responded by controlling one of the HDDs, such a request as well as the Read request is determined to be Yes and the process may proceed to step S402. For example, if the request is another processing request, such as a Write request, which requires simultaneous control of a plurality of HDDs, the request is determined to be No and the process proceeds to step S404.

In a case where Yes is determined in step S401, in step S402, the mirroring control unit 201 confirms whether one HDD (here, the HDD 301) is available for use. More specifically, in step S402, the mirroring control unit 201 repeats the confirmation in step S402 until the permission state information indicating that Read is only permitted is written to the data storage unit 202.

In a case where Yes is determined in step S402, that is, the permission state information indicating that Read is only permitted is written to the data storage unit 202, the mirroring control unit 201 proceeds to step S403. In step S403, the mirroring control unit 201 responds to the main controller 100 by controlling the HDD 301 to execute the processing requested by the main controller 100. For example, if the request is the Read request, the mirroring control unit 201 reads data from the HDD 301 to transfer the data to the RAM 103 to complete the processing. As described above, not only the Read request, but also a request which can be responded by controlling one of the HDDs may be executed here.

On the other hand, in a case where No is determined in step S401, that is, the request is determined not to be the Read request, in step S404, the mirroring control unit 201 confirms whether all the storage devices (here, the HDD 301 and HDD 302) are available for use. More specifically, the mirroring control unit 201 repeats the confirmation in step S404 until permission state information indicating that all the requests are permitted is written to the data storage unit 202.

In a case where Yes is determined in step S404, that is, the permission state information indicating that all the requests are permitted is written to the data storage unit 202, the process proceeds to step S405. In step S405, the mirroring control unit 201 responds to the main controller 100 by controlling the HDD 301 and HDD 302 to execute the processing requested by the main controller 100. For example, if the request is the Write request, the received data is written to the HDD 301 and HDD 302 to complete the processing.

It should be noted that in the above embodiment, the explanation has been given of the case where once the power control unit 400 receives the notification of the completion of the initialization of the HDD 301, the power control unit 400 moves to a state in which Read is only permitted and upon receipt of the Read request, the power control unit 400 controls the HDD 301 to respond to the request. However, the present embodiment does not specify the order of controlling the HDD 301 and HDD 302. That is, also in a case where the notification of the completion of the initialization is received first from the HDD 302, the power control unit 400 may move to a state in which Read is only permitted and, upon receipt of the Read request, control the HDD 302 to respond to the request.

Further, in the above embodiment, two types of requests, the Read request and the Write request, have been described as examples, but requests are not limited to these requests. Specifically, in a configuration in which mirroring is performed, a request which can be processed as long as at least one HDD is performed may be permitted with the at least one HDD in activation. Furthermore, in the configuration in which mirroring is performed, processing which cannot be processed before all or a plurality of HDDs are performed (that is, mirroring consistency cannot be achieved) may be processed in such a manner that permission is not given until the corresponding HDD is activated.

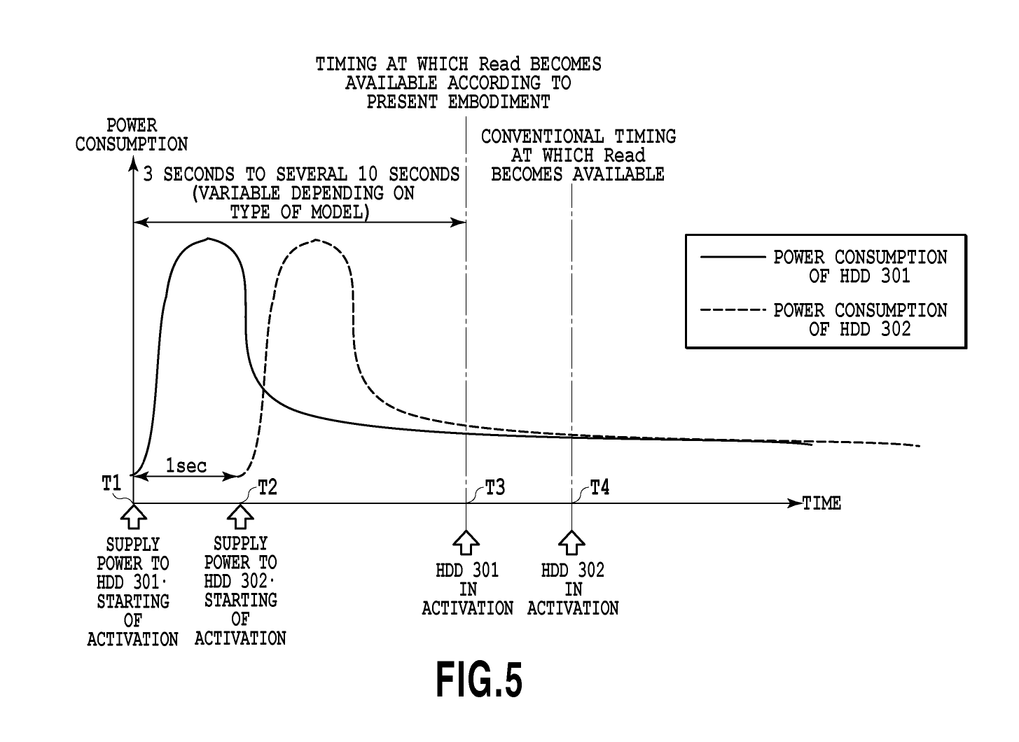

FIG. 5 is a chart showing an example of effects according to the present embodiment. The vertical axis and lateral axis in FIG. 5 show power consumption and time, respectively. First, at time T1, power is supplied to the HDD 301. At this point of start-up, a lot of power is consumed for processing, such as spin-up. Then, at time T2 at which power consumption at start-up of the HDD 301 is reduced, power is supplied to the HDD 302. At the subsequent time T3, the mirroring control unit 201 receives, from the HDD 301, the notification of the completion of the initialization at start-up of the HDD 301. Thereafter, at time T4, the mirroring control unit 201 receives, from the HDD 302, the notification of the completion of the initialization at start-up of the HDD 302. While in conventional techniques, the Read request is executed at time T4, the processing according to the present embodiment enables the Read request to be executed at time T3. Accordingly, it is possible to advance timing of reading data on firmware or the like necessary for the initialization of the main controller 100 at start-up of the MFP 1, resulting in accelerating the start-up timing of the MFP 1.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, in a configuration in which mirroring of a plurality of HDDs is performed by using the disk array device and the timing of power supplied to the HDDs at power-on is shifted to reduce the peak power, it is possible to advance the timing at which the HDDs can be read.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-023118, filed Feb. 9, 2015, which is hereby incorporated by reference wherein in its entirety.

What is claimed is:

1. A storage control device for controlling data stored in a first storage device and a second storage device, the storage control device comprising:
a detection unit configured to detect activation states of the first storage device and the second storage device; and
a control unit configured
to permit a first processing request, with respect to the storage devices, the first processing request capable of being processed with only activation of the first storage device, in a case where the detection unit detects that only the first storage device is activated, and
to permit processing requests including the first processing request with respect to the storage devices, in a case where the detection unit detects that the first storage device and the second storage device are activated.

2. The storage control device according to claim 1, wherein the first processing request is a Read request and the processing requests with respect to the storage devices including the first processing request include a Write request.

3. A storage control device for controlling data stored in a first storage device and a second storage device, the storage control device comprising:
a receiving unit configured to receive a processing request with respect to the first storage device and the second storage device; and
a control unit configured
to execute a Read request, in a case where a processing request received by the receiving unit is the Read request and it is determined that at least one storage device of the first storage device and the second storage device is in activation, and
to wait a Write request until it is determined that the first storage device and the second storage device are both activated, in a case where a processing request received by the receiving unit is the Write request and it is determined that none of the first storage device and the second storage device is in activation.

4. The storage control device according to claim 1, wherein in a case where notification of completion of initialization at power-on is received from the first storage device, it is determined that the first storage device is in activation.

5. A control method in a storage control device for controlling data stored in a first storage device and a second storage device, the method comprising the steps of:
receiving a processing request with respect to the first storage device and the second storage device;
executing a Read request, in a case where a processing request received in the receiving step is the Read request and it is determined that at least one storage device of the first storage device and the second storage device is in activation; and
waiting a Write request until it is determined that the first storage device and the second storage device are both activated, in a case where a processing request received in the receiving step is the Write request and it is determined that none of the first storage device and the second storage device is in activation.

6. A non-transitory computer readable storage medium storing a program which causes a computer to perform a control method in a storage control device for controlling data stored in a first storage device and a second storage device, the method comprising the steps of:
receiving a processing request with respect to the first storage device and the second storage device;
executing a Read request, in a case where a processing request received in the receiving step is the Read request and it is determined that at least one storage device of the first storage device and the second storage device is in activation; and
waiting a Write request until it is determined that the first storage device and the second storage device are both activated, in a case where a processing request received in the receiving step is the Write request and it is determined that none of the first storage device and the second storage device is in activation.
